(19) United States
(12) Patent Application Publication
(10) Pub. No.: US 2008/0032676 A1
(43) Pub. Date: Feb. 7, 2008

(54) MOBILE ELECTRONIC DEVICE WITH TELEPHONE AND MUSIC FUNCTION

(76) Inventors: Christian Kraft, Frederiksberg (DK); Peter Dam Nielsen, Lyngby (DK)

Correspondence Address: PERMAN & GREEN, 425 POST ROAD, FAIRFIELD, CT, 06824, US

(21) Appl. No.: 11/461,791

(22) Filed: Aug. 2, 2006

(51) Int. Cl. H04M 3/42

(52) U.S. Cl. 455/414.1

(57) ABSTRACT

A mobile electronic device with a phone function and a music player function. The device includes a recording medium containing a plurality of songs, a music player operable to play songs, an incoming call detection unit, and a ringing tone selection unit for selecting a previously played song as the ringing tone to be used upon detection of an incoming call. The selection criterion for selecting the previously played song is user selectable and can for example be the song last played on the music player. Thus, the ringing tone automatically follows the musical preferences of the user.

### FIELD

The aspects of the invention relate to a mobile electronic device with a telephone function and a music reproduction function, and specially relates to the operation of the device when an incoming call is detected.

### BACKGROUND

Mobile electronic devices that have both telephone and music reproduction functions are increasingly becoming popular. The interaction between the music reproduction functions and the telephone functions create various new problems and offers new possibilities. U.S. Pat. No. 6,947,728 discloses a mobile phone with a music player function. When the mobile phone detects an incoming call, the signal of the music player is faded out and a ringing tone is faded in when a call is detected and music is being played. In this type of device the songs for the music player that are typically stored in a compressed format (such as MP3) in the memory of the device can be used as ringing tones.

Especially young people's musical taste tends to change quickly and follows the fast evolving musical hit charts. Therefore, there is a need for being able to change ringing tone equally fast. However, changing the ringing tone requires the user to go to the menu structure and change the settings for the ringing tone. Although changing this setting is as such not difficult, it requires a positive action and involves a relatively tedious formality, which is consequently not something that users wish to do regularly.

### DISCLOSURE

On this background, one embodiment provides a mobile electronic device with a telephone function and a music reproduction function in which the above problem is at least partially reduced.

A mobile electronic device is provided with a telephone function and a music reproduction function. The device includes a recording medium having recorded therein a plurality of songs in the form of musical data, a music player operable to play songs, the music player including a reproduction unit operable to reproduce music data recorded in the recording medium, an incoming call detection unit operable to detect an incoming call, and a ringing tone selection unit for selecting a previously played song as the ringing tone to be used upon detection of an incoming call.

The automatic selection of the ringing tone makes it much easier and faster for the user to regularly change his/her ringing tone. Further, the automatic selection of the ringing tone makes it possible for the user to always have a ringing tone which reflects his/her current “favorite music” since this music is most likely anyway played in the music player.

The mobile electronic device may further include a reproduction unit that is configured to reproduce the song selected by the ringing tone selection unit upon detection of an incoming call.

Preferably, the ringing tone selection unit is configured to select the last song played by the music player as the ringing tone. Thus, the ringing tone will automatically follow the last played and will be continuously up-to-date.

Alternatively, the ringing tone selection unit is configured to select the most frequently played song during a given time interval as the ringing tone. Thus, the ringing tone will automatically be the most popular song played on the music player.

As another alternative, the songs that are recorded on the recording medium are organized in play lists, and the ringing tone selection unit can be configured to select the first song from the last played play list as the ringing tone.

Further, the mobile electronic device may comprise selection means allowing a user to define the criteria for automatically selecting the ringing tone from the songs that are recorded on the recording medium.

Preferably, the reproduction unit is operable to reproduce the last played song from the position within the song, where reproduction of the last played song was stopped.

The recording medium may include a default ringing tune, and the ringing tone selection unit may be operable to select the default ringing tone if the ringing tone selection criteria are either inapplicable or if the song to be selected is no longer present in the recording medium.

In one embodiment a method includes selecting a ringing tone in a mobile electronic device with a telephone function and a music player, by automatically selecting a song played previously on the music player and reproducing the selected song when an incoming call is detected.

Preferably, the selected song is the last song that has been played on the music player.

Alternatively, the selected song is a song that has been played most frequently on the music player during a given time interval.

It is also possible that the selected song is the first song of the last played play list.

The method may further comprise enabling the user to define criteria according to which a previously played song is selected as ringing tone.

In another embodiment a software product is provided for use in a mobile electronic device that is provided with a telephone function and a music player function, the software product comprising software code for playing songs, including software code for reproducing music data recorded in a recording medium associated with the mobile electronic device, software code for detecting incoming calls, and software code for selecting a ringing tone from previously played songs that are recorded in the recording medium as the ringing tone to be used upon detection of an incoming call.

Preferably, the software product further includes software code for reproducing the selected song upon detection of an incoming call.

Further objects, features, advantages and properties of the mobile electronic device, the method and the software product according to the invention will become apparent from the detailed description.

### BRIEF DESCRIPTION OF THE DRAWINGS

In the following detailed portion of the present description, the invention will be explained in more detail with reference to the exemplary embodiments shown in the drawings, in which:

FIG. 1 is a front view of a mobile electronic device according to a preferred embodiment of the invention,

FIG. 2 is a block diagram illustrating the general architecture of the mobile electronic device illustrated in FIG. 1,

FIG. 3 shows three screenshots of the display of the mobile electronic device illustrated in FIG. 1, and

FIG. 4 is a flow chart illustrating the operation of the automatic ringing tone selection in the mobile electronic device according to the invention.

### DETAILED DESCRIPTION OF PREFERRED EMBODIMENTS

In the following detailed description, the device and the method according to the invention in the form of a personal computer, PDA, mobile terminal or a mobile communication terminal in the form of a cellular/mobile phone will be described by the preferred embodiments.

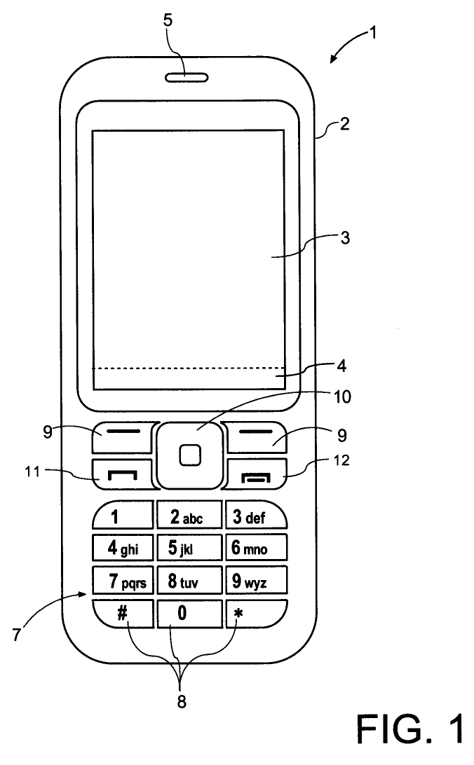

FIG. 1 illustrates a first embodiment of a mobile terminal according to the invention in the form of a mobile telephone by a front view. The mobile phone 1 comprises a user interface having a housing 2, a display 3, an on/off button (not shown), a speaker 5 (only the opening is shown), and a microphone 6 (not visible in FIG. 1). The phone 1 according to the first preferred embodiment is adapted for communication via a cellular network, such as the GSM 900/1800 MHz network, but could just as well be adapted for use with a Code Division Multiple Access (CDMA) network, a 3G network, or a TCP/IP-based network to cover a possible VoIP-network (e.g. via WLAN, WIMAX or similar) or a mix of VoIP and Cellular such as UMA (Universal Mobile Access).

The keypad 7 has a first group of keys 8 as alphanumeric keys, by means of which the user can enter a telephone number, write a text message (SMS), write a name (associated with the phone number), etc. Each of the twelve alphanumeric keys 8 is provided with a figure “0-9” or a sign “#” or “*”, respectively. In alpha mode each key is associated with a number of letters and special signs used in the text editing.

The keypad 2 has additionally a second group of keys comprising two softkeys 9, two call handling keys (offhook key 11 and onhook key 12), and a 5-way navigation key 10 (up, down, left, right and center: select/activate). The function of the softkeys 9 depends on the state of the phone, and navigation in the menu is performed by using the navigation-key 10. The present function of the softkeys 9 is shown in separate fields (soft labels) in a dedicated area 4 of the display 3, just above the softkeys 9. The two call handling keys 11,12 are used for establishing a call or a conference call, terminating a call or rejecting an incoming call. This key layout is characteristic for e.g. the Nokia 6230i™ phone.

The navigation key 10 is a four- or five-way key which can be used for cursor movement, scrolling and selecting (five-way key) and is placed centrally on the front surface of the phone between the display 3 and the group of alphanumeric keys 7.

A releasable rear cover (not shown) gives access to the SIM card (not shown), and the battery pack (not shown) in the back of the phone that supplies electrical power for the electronic components of the mobile phone 1.

The mobile phone 1 has a flat display 3 that is typically made of an LCD with optional back lighting, such as a TFT matrix capable of displaying color images. A touch screen may be used instead of a conventional LCD display.

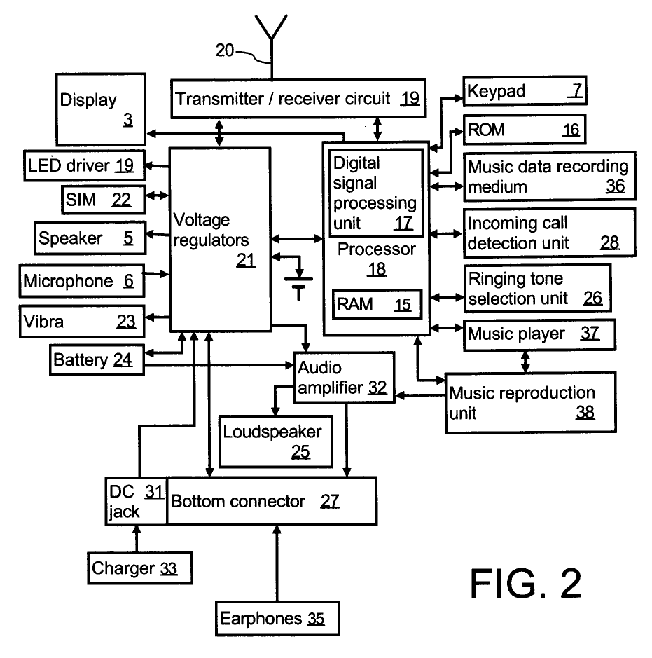

FIG. 2 illustrates in block diagram form the general architecture of the mobile phone 1 constructed in accordance with the present invention. The processor 18 controls the operation of the terminal and has an integrated digital signal processor 17 and an integrated RAM 15. The processor 18 controls the communication with the cellular network via the transmitter/receiver circuit 19 and an internal antenna 20. A microphone 6 coupled to the processor 18 via voltage regulators 21 transforms the user's speech into analogue signals, the analogue signals formed thereby are A/D converted in an A/D converter (not shown) before the speech is encoded in the DSP 17 that is included in the processor 18. The encoded speech signal is transferred to the processor 18, which e.g. supports the GSM terminal software. The digital signal-processing unit 17 speech-decodes the signal, which is transferred from the processor 18 to the speaker 5 via a D/A converter (not shown).

The voltage regulators 21 form the interface for the speaker 5, the microphone 6, the LED drivers 19 (for the LEDS backlighting the keypad 7 and the display 3), the SIM card 22, battery 24, the bottom connector 27, the DC jack 31 (for connecting to the charger 33) and the audio amplifier 32 that drives the (hands-free) loudspeaker 25.

The processor 18 also forms the interface for some of the peripheral units of the device, including a (Flash) ROM memory 16, the graphical display 3, the keypad 7, the ringing tone selection unit 26, an incoming call detection unit 28, a music data recording medium 36, a music player 37 and a music reproduction unit 38.

The incoming call detection unit 28 is part of the phone software (not shown) and is operable to detect incoming calls and alert the user of an incoming call by activating one of several alerting means that are available in the mobile phone 1. These alerting means may include flashing of the display 3 by (intermittently) activating the backlighting of the display 3, activation of the vibration unit 23 and/or the initiation of the playing of a ringing tone by the music reproduction unit 38.

Music in the form of songs is recorded as music data on the recording medium 36. The recording medium is a flash ROM memory, for example in the form of an exchangeable memory card. The music data can be stored on the recording medium by downloading the music data from a personal computer (not shown) via a cable (not shown) that is attached to the bottom connector 27. The music could also be written to the recording medium 36 when it is inserted into an external device (not shown).

The music player 37 can be a multimedia player that can play media with another format than music, such as for example video data. The music player 37 is part of the software on the mobile phone and provides a user interface for selecting, playing, pausing, stopping, forwarding, rewinding, and handling songs. The handling of songs includes saving songs or albums, renaming songs or albums, adding or modifying attributes associated with songs, creating playlists, and sorting songs in accordance with attributes associated with the songs.

The music reproduction unit 38 is part of the software of the mobile phone and is operable to reproduce music data that is stored in one of the memories or recording media of the mobile phone 1. The music data can be digitized music, preferably in a compressed format, such as the MP3 format or instrumental data, such as ringing tones in the form of MIDI files. Any other known music data formats can be used in connection with the invention.

The reproduced music is routed to the earphones 35 when earphones are connected to the bottom connector 27 else, the reproduced music is routed to the loudspeaker 25. Depending on user settings, ringing tones may be routed to the loudspeaker 25 even if earphones 35 are connected to the bottom connector 27.

The ringing tone selection unit 26 is part of the software on the mobile phone 1 and is operable to select one of the songs that has been played on the music player 37 as the ringing tone that is played upon detection of an incoming call by the incoming call detection unit 28.

The criteria according to which the ringing tone selection unit selects the previously played song can vary and can be user controlled by the user changing the settings relating to the selection of the ringing tone in the menu structure of the mobile phone 1.

One possible selection criterion is to assign the song last played on the music player 37 as the ringing tone. Thus, the song that was being played when the music player was stopped for the last time is automatically selected as the new ringing tone. Thus, when the user has started the audio player 37 to play several songs, it is the song that was being played when the user stopped that is being selected as the new ringing tone.

A sub-selection criterion is to start playing the selected song from the position inside the song at which the last playback was ended. Thus, the user can stop the reproduction of the song that is to be selected as the new ringing tone just before his/her favorite passage of the song. Thereby, the ringing tone will commence with the favorite passage of the user when an incoming call is detected.

Another possible selection criterion is to assign the song that has been most frequently played on the music player 37 during a given period of time, for example during the last two weeks, as the new ringing tone. Thus, the song that has been most frequently played on the music player 37 during the last two weeks is automatically selected as the ringing tone that is played when an incoming call is detected.

Yet another possible selection criterion is to assign the first song of the last played playlist on the music player series 7 as the new ringing tone.

It will be evident that the selection criterion could be related to any other aspect of the songs that have been played on the music player 37. For example the criterion could relate to the attributes associated with the songs, such as the album name, the musician name, the musical style, etc. The selection criterion can be determined by the user via the settings menu in the menu structure of the phone. In a preferred embodiment the selection criterion for the ringing tone is accessible via both the ringing tone settings menu and the music player settings menu.

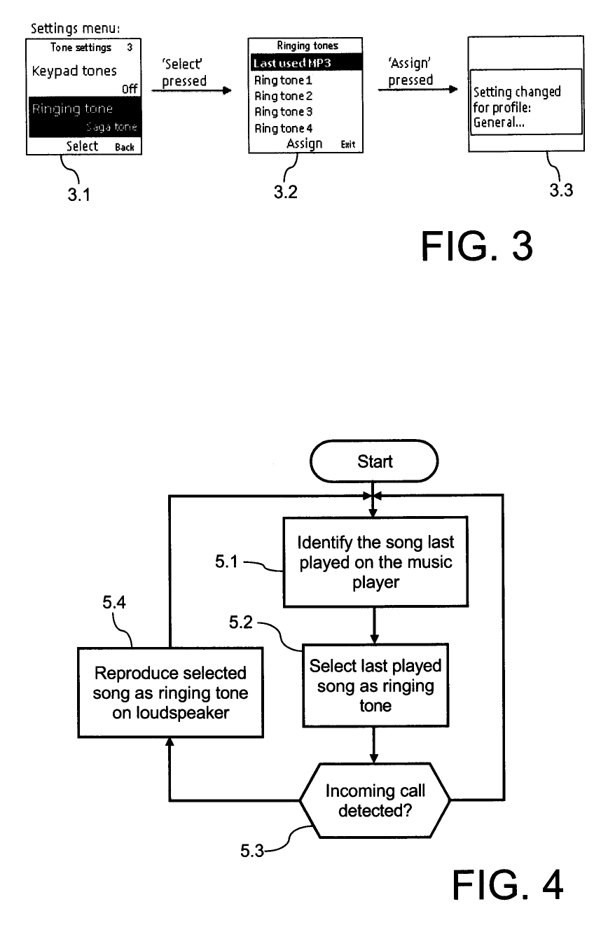

FIG. 3 illustrates in three subsequent screenshots 3.1, 3.2 and 3.3 how the selection criterion can be modified by the user. In screen 3.1 the user has accessed the tone settings menu that includes the menu items “Keypad tones” and “Ringing tone”. The menu item “Ringing tone” has been highlighted and by pressing the navigation key 10 “Select” the mobile phone 1 arrives at screenshot 3.2. In screenshot 3.2 the selectable ringing tones are listed. The first (and highlighted) item on the list is the “Last used MP3”. By selecting “Assign” trough pressing the navigation key 10 the ringing tone selection is changed (in this case for the profile: “General”) to the song last played on the music player 37. The selection of other material for the ringing tone selection unit is similar.

FIG. 4 is a flowchart illustrating the ringing tone selection procedure according to a preferred embodiment of the invention. In step 5.1 the ringing tone selection unit 26 identifies the song that was last played on the music player 37. In step 5.2 the ringing tone selection unit 26 selects the last played song as the new ringing tone. In step 5.3 the incoming call detection unit 28 monitors incoming calls. If no incoming call is detected, the process returns to step 5.1. If an incoming call is detected by the incoming call detection unit 28, the music reproduction unit 38 reproduces the song selected by the ringing tone selection unit 26 via the loudspeaker 25.

The term “comprising” as used in the claims does not exclude other elements or steps. The term “a” or “an” as used in the claims does not exclude a plurality. The single processor or other unit may fulfill the functions of several means recited in the claims, such as for example the music player, the reproduction unit for reproducing music data, the incoming call detection unit operable to detect an incoming call, and the ringing tone selection unit.

Although the embodiments have been described in detail for purpose of illustration, it is understood that such detail is solely for that purpose, and variations can be made therein by those skilled in the art without departing from the scope of the invention.

1. A mobile electronic device with a telephone function and a music reproduction function, said device comprising
a recording medium having recorded therein a plurality of songs in the form of musical data,
a music player operable to play songs, said music player including a reproduction unit operable to reproduce music data recorded in the recording medium,
an incoming call detection unit operable to detect an incoming call, and
a ringing tone selection unit for selecting a previously played song as the ringing tone to be used upon detection of an incoming call.

2. A mobile electronic device according to claim 1, wherein the reproduction unit is configured to reproduce the song selected by the ringing tone selection unit upon detection of an incoming call.

3. A mobile electronic device according to claim 1, wherein said ringing tone selection unit is configured to select the last song played by the music player as the ringing tone.

4. A mobile device according to claim 1, wherein said ringing tone selection unit is configured to select the most frequently played song during a given time interval as the ringing tone.

5. A mobile device according to claim 1, wherein said songs that are recorded on said recording medium are organized in play lists, and said ringing tone selection unit is configured to select the first song from the last played play list as the ringing tone.

6. A mobile device according to claim 1, further comprising selection means allowing a user to define the criteria for selecting the ringing tone from the songs that are recorded on said recording medium.

7. A mobile device according to claim 3, wherein the reproduction unit is operable to reproduce the last played song from the position within the song where reproduction of the last played song was stopped.

8. A mobile device according to claim 1, wherein said recording medium includes a default ringing tone, and said ringing tone selection unit being operable to select the default ringing tone if the ringing tone selection criteria are either inapplicable or if the song to be selected is no longer present in the recording medium.

9. A method of selecting a ringing tone in a mobile electronic device with a telephone function and a music player, comprising automatically selecting a song played previously on said music player and reproducing the selected song when an incoming call is detected.

10. A method according to claim 9, wherein the selected song is the last song that has been played on said music player.

11. A method according to claim 9, wherein the selected song is a song that has been played most frequently on said music player during a given time interval.

12. A method according to claim 9, wherein the selected song is the first song of the last played play list.

13. A method according to claim 9, further comprising enabling the user to define criteria according to which a previously played song is selected as ringing tone.

14. A software program product executing the method according to claim 9 when run on a processor.

15. A software product for use in a mobile electronic device that is provided with a telephone function and a music player function, said software product comprising:
software code for playing songs, including software code for reproducing music data recorded in a recording medium associated with the mobile electronic device,
software code for detecting incoming calls, and
software code for selecting a ringing tone from previously played songs that are recorded in the recording medium as the ringing tone to be used upon detection of an incoming call.

16. A software product according to claim 15, further including software code for reproducing the selected song upon detection of an incoming call.
